(19) United States
(12) Patent Application Publication
(10) Pub. No.: US 2010/0150002 A1
(43) Pub. Date: Jun. 17, 2010

(54) Method and System for Determining the Cause of Trunk Group Blocking

(76) Inventors: David KIMBLE, Danville, CA (US); Richard Burke, Vacaville, CA (US)

Correspondence Address: AT & T Legal Department - FKM, AT & T LEGAL DEPARTMENT,, ATTN: PATENT DOCKETING ROOM 2A-207, BEDMINSTER, NJ, 07921, US

(21) Appl. No.: 12/333,758

(22) Filed: Dec. 12, 2008

(51) Int. Cl. H04L 12/26

(52) U.S. Cl. 370/252

(57) ABSTRACT

Described herein are systems and methods for categorizing a blocked trunk group event into likely causes, thereby improving the ability to prevent and/or resolve any disruptions in services. An exemplary method includes analyzing network traffic from at least one trunk group, detecting a trunk group blocking event, and categorizing a cause of the trunk group blocking event based on the analyzed network traffic. An exemplary system includes a trunk group analyzing tool for analyzing network traffic from at least one trunk group, detecting a trunk group blocking event, and categorizing a cause of the trunk group blocking event based on the analyzed network traffic.

### BACKGROUND

In a communications network, a trunk may be described as a single transmission channel between two points that are switching centers, nodes, or both. Accordingly, a trunk group may be a collection of circuits of a common type that originate from the same location in order to serve a joint purpose. Therefore, the use of trunks allows for a communications system to provide network access to many clients through sharing a set of lines or frequencies instead of providing them individually to the clients. Traffic flow problems, or outages, within a trunk group can include any number of conditions, such as out-of-service trunks, busy conditions at all the trunks, or trunk group blocking. Trunk group blocking described a scenario wherein all trunks are being used to carry other calls, thereby preventing any additional arriving call from being carried by that trunk group. If the trunk group is a “final” type group, the arriving call is “blocked”. However, if the trunk group is any other type of group, the call may be “overflowed” to a “final” or “immediate” trunk group type.

According to the Telecommunications Act of 1996, several changes were introduced that affected both long distance carriers and local exchange carriers. While the Act allowed for local exchange carriers to provide local service, Section 271 of the Act imposes penalties on local exchange carriers for “common transport” final trunk group blocking. However, the Act also provides for exemptions to the penalties if the common transport final trunk blocking was the result of a “call blast” event. Call blasting is a new and growing telecommunications technique involving pre-recorded phone messages that are broadcasted to hundreds or thousands of call recipients at one time. New calling devices for generating a call blast event, such as auto-dialers used by school districts to announce school closures and police departments to announce public warnings, are on the rise. In addition, commercial phone messages are currently being automatically broadcast to customers in bulk fashion via such call blasting techniques.

Typically, a trunk group blocking event is presumed to be the result of added calling from sporadic call-increase or by overflow from one or more other trunk groups. Rather than attributing the occurrence of trunk blocking to a presumed event, a communications service provider would find advantageous a system that actually determines the particular cause of the blocking, especially since the detection of a call blast induced blocking would absolve the provider from the above-mentioned penalties.

### SUMMARY OF THE INVENTION

The present invention is generally related to systems and methods for categorizing a blocked trunk group event into likely causes, thereby improving the ability to prevent and/or resolve any disruptions in services. One exemplary embodiment is related to a method including analyzing network traffic from at least one trunk group, detecting a trunk group blocking event, and categorizing a cause of the trunk group blocking event based on the analyzed network traffic.

A further exemplary embodiment is related to a system including a trunk group analyzing tool for analyzing network traffic from at least one trunk group, detecting a trunk group blocking event, and categorizing a cause of the trunk group blocking event based on the analyzed network traffic.

A further exemplary embodiment is related to a computer readable storage medium storing a set of instructions executable by a processor, wherein the set of instructions are operable to analyze network traffic from at least one trunk group, detect a trunk group blocking event, and categorize a cause of the trunk group blocking event based on the analyzed network traffic.

### BRIEF DESCRIPTION OF THE DRAWINGS

FIG. 1A shows an exemplary communication system for categorizing a blocked trunk group event into likely causes according to an exemplary embodiment of the present invention.

FIG. 1B shows an exemplary communication system for receiving trunk group data from a plurality of switches according to an exemplary embodiment of the present invention.

FIG. 2 shows an exemplary table summarizing a plurality of potential causes of a trunk group blocking event as analyzed according to an exemplary embodiment of the present invention

FIG. 3 shows an exemplary method for categorizing a blocked trunk group event into likely causes according to an exemplary embodiment of the present invention.

### DETAILED DESCRIPTION

The exemplary embodiments of the present invention may be further understood with reference to the following description of exemplary embodiments and the related appended drawings, wherein like elements are provided with the same reference numerals. The exemplary embodiments of the present invention are related to systems and methods for categorizing a blocked trunk group event into likely causes, thereby improving the ability to prevent and/or resolve any disruptions in services. Accordingly, the exemplary embodiments may serve as a tool for determining potential reasons for the blocked trunk group and provide personnel (e.g., administrators, trunking engineers, etc.) with an immediate basis for their actions as well as evidence to support their decisions. Specifically, the tool may analyze recorded trunk data in order to identify a cause of a blocking event. In addition, the exemplary embodiments may allow for telecommunication service carriers to avoid being subjected to state-imposed penalties for trunk blocking.

Historically, trunk-blocking events were assumed to be caused by random increases in calling or by overflow from other trunk groups. However, the exemplary embodiments of the present invention allows for each trunk-blocking event to be classified, or categorized, into one of a number of potential causes or “traffic phenomena”, such as Internet dial-up calling, “call-blast” events from auto-dialers, etc. Most often, these trunk traffic phenomena can change the characteristics of the traffic on a trunk group. Accordingly, the exemplary embodiments of the present invention may examine historical characteristics of traffic following the occurrence of a trunk group blocking in order to identify which phenomenon caused the event. Knowing the cause of the trunk blocking has become increasingly important due to the fact that the cause may determine the course of action required to mitigate the blocking, if any action is required at all.

It is important to note that if the service carriers are able to establish that a trunk block event was caused by a call blast, the carrier may avoid penalties imposed by state government regulations (e.g., Section 271 trunk group blocking). Specifically, a call blast event may be exempt from these types of penalties. With the increased usage of new calling devices such as auto-dialers, trunk group blocking events has grown into a relatively new and frequent phenomenon.

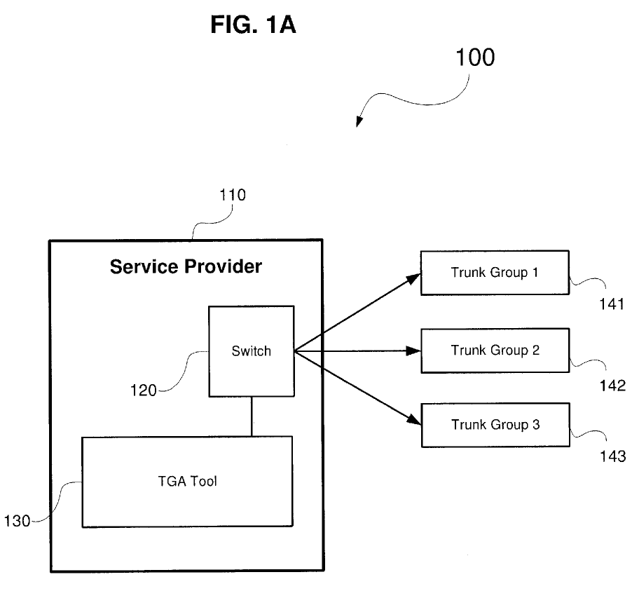

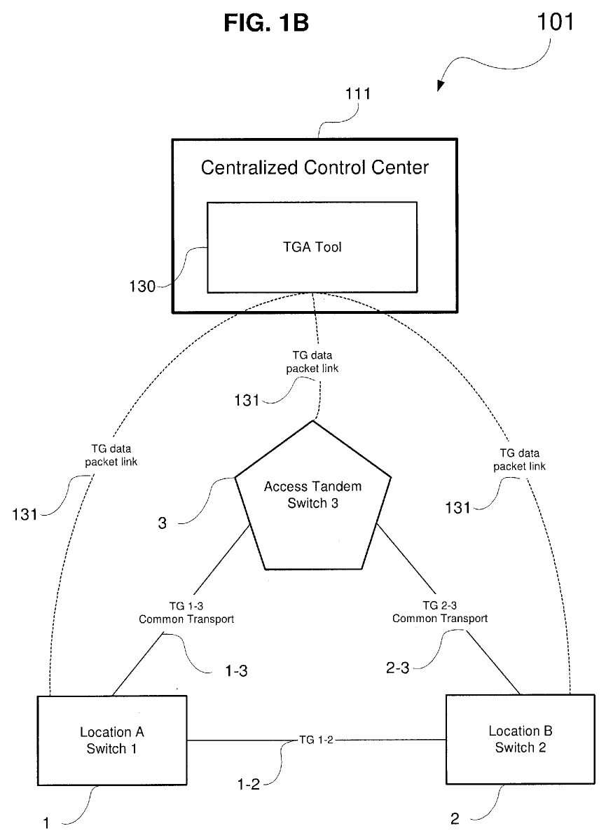

FIG. 1A shows an exemplary communication system 100 for categorizing a blocked trunk group event according to its cause. The communication system 100 may include a service provider 110 (e.g., a telecommunication carrier), at least one network switch 120, and an exemplary trunk group analyzing tool, or simply “TGA tool” 130. The switch 120 may be, for example, a time division multiplexing (“TDM”) switch that is connected to a number of trunk groups (“TG”), such as TG1 141, TG2 142, and TGn 143. Each of these TGs 141-143 may carry trunk group traffic (e.g., telephone calls) from the service provider 110 to various other public switched telephone network (“PSTN”) switches, such as local, area, and primary tandem switches, etc. It should be noted that while the system 100 illustrated in FIG. 1A includes three TGs 141-143, any number of TGs may be connect to the switch 120 and subsequently analyzed by the TGA tool 130.

According to the exemplary embodiments of the present invention, the TGA tool 130 may allow the service provider 110 to determine the cause of a trunk group blocking occurring on one of the TGs 141-143. As described above, the TGA tool 130 may analyze recorded trunk data leading up to the blocking event in order to identify one or more casual characteristics, or trait, of a blocking event. Specifically, upon the occurrence of a trunk blocking event, the TGA tool 130 may examine historical data to categorize the cause.

It should be noted that the trunk group statistics may be collected during a predetermined duration of time, such as, for example, the statistics may be collected hourly and then stored daily. Accordingly, the TGA tool 130 may use this historical data (e.g., data collected over the past 12 months) when comparing to current group statistics. Over time, this historical data the hourly statistics of a current blocking event in order to determine the cause of the block event.

Therefore, the TGA tool 130 provides the service provider 110 with the ability to classify the trunk group blocking event. As will be described in greater detail below, a variety of trunk blocking phenomena may change the traffic on any of the TGs 141-143. These phenomena may include, but are not limited to, increased calls of the same average length and arrival rate with no immediate increase in trunk group size, reduction in the trunk size (e.g., increase in the utilization, increase in blocking, etc.), added dial-up Internet traffic, call blast events (e.g., school announcements, radio contest, etc.), and inadvertent trunk transactions that send overflow traffic to a trunk group.

As discussed above, state governments may impose penalties to the service provider 110 for any trunk group blocking events. However, any event that occurs as the result of a call blast may be exempt from these regulation penalties. Accordingly, the TGA tool 130 may determine whether the event is an exempt event, thereby allowing the service provider 110 to avoid such penalties. Furthermore, by determining the cause of the event, the TGA tool 130 also allows the service provider 110 to avoid performing any unnecessary augmentations on the trunk groups. Augmenting these trunk groups without knowing the cause of the trunk group blocking may prove to be prohibitively expensive while providing little true benefit to normal end-users (e.g., callers).

It should be noted that each trunk blocking phenomena may demonstrate unique characteristics that allow the TGA tool 130 to distinguish one cause for the event from another. These causal characteristics may include statistics such as, but not limited to, the peg counts (e.g., number of calls attempted), average holding times (“AHTs”), offered loads (e.g., the number of trunk occupied), trunk group size (e.g., number of trunk available within a group to carry calls), utilization (e.g., ratio of the average offered loads to the total trunk size), block group blocking (e.g., proportion of calls not able to be completed), and peakedness (e.g., the ratio of the statistical variance of occupied busy-hour trunks to the average occupied trunks). Accordingly, the exemplary embodiments of the present invention may analyze these characteristics in order to determine the cause of a given trunk blocking event.

FIG. 1B shows an exemplary communication system 101 for receiving trunk group data from a plurality of switches according to an exemplary embodiment of the present invention. For instance, the communication system may include centralized control center 111 and a first switch 1 at location A, a second switch 2 at location B, and an access tandem switch 3. The system 101 may also include three TG, namely TG 1-3, TG 1-2, TG 2-3. Specifically, the access tandem switch 3 may be connected to the first switch 1 via the common transport TG 1-3, and may be connected to the second switch 2 via the common transport TG 2-3. The first switch 1 may be connected to the second switch 2 via TG 1-2.

According to the exemplary embodiments of the present invention, the centralized control center 111 may include the TGA tool 130 for analyzing the traffic throughout the system 101. Specifically, the TGA tool 130 may be in communication each of the first switch 1, the second switch 2, and the access tandem switch 3 via TG data packet links 131. Accordingly, the TGA tool 130 may analyze recorded traffic data on the TG data packet links 131 in order to identify one or more casual characteristics of a blocking event occurring on any one of the TGs (e.g., TG 1-2, TG 2-3, and TG 2-3). Upon the occurrence of a trunk blocking event, the TGA tool 130 may examine historical data received from the first switch 1, the second switch 2 and the access tandem switch 3 in order to categorize the cause.

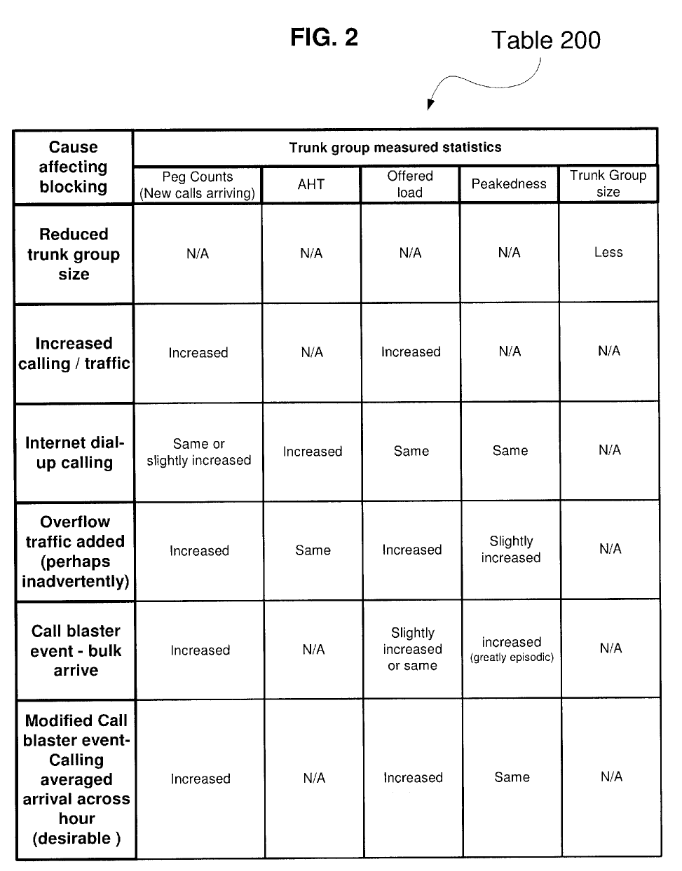

FIG. 2 shows an exemplary table 200 summarizing a plurality of potential causes of a trunk group blocking event as analyzed by the TGA tool 130, according to an exemplary embodiment of the present invention. As noted above, each of the potential causes for the trunk blocking phenomena may demonstrate unique characteristics that allow the TGA tool 130 to distinguish one cause for the event from another. Furthermore, it should be noted that there may be more than one cause for a trunk group to block calls. For instance, if a trunk group size is reduced and blocking occurred, the reduction may be determined to be a contributing cause regardless of other causes.

A first potential cause of a trunk group blocking event may be due to a reduction in the trunk group size. The exemplary characteristics exhibited by such a reduction would include an increase in the utilization, a possible increase in blocking, no change in the peg count, no change in the offered load, no change in the AHT, and no change in the peakedness.

A second potential cause of a trunk group blocking event may be due to increased traffic (e.g., increased calls of the same average call length and arrival rate) with no immediate increase in trunk group size. The exemplary characteristics exhibited by such an increased in traffic would include an increased the offered load, an increase in utilization, no change in the average holding time (“AHT”), an increased peg count, possible increase in blocking, and no change in peakedness.

A third potential cause of a trunk group blocking event may be due to added dial-up Internet calls traffic. The exemplary characteristics exhibited by such Internet calls traffic would include an increased in AHT, an increased offered load, an increase in utilization, possible increase in blocking, nearly the same peg count, and no change in the peakedness. It should also be noted that this added traffic may have the effect of subtracting trunk group size.

A fourth potential cause of a trunk group blocking event may be due to trunk transactions that send overflow traffic to a trunk group. For example, these trunk transactions may be the result of inadvertent or erroneous instructions. The exemplary characteristics exhibited by such an addition of overflow traffic would include an increased in peg count, an increase in offered load, an increase in utilization, no change to the average holding time (e.g., around 3 minutes), and in increase in peakedness. However, unlike the episodic increase in peakedness of the call blast event, the increase in peakedness caused by the overflow traffic may be described as a chronic increase, until it is corrected.

A fifth potential cause of a trunk group blocking event may be due to a call blast event. The exemplary characteristics exhibited by such a call blast event would include a substantial increase in the peakedness, an increase in peg count, no change or a decrease in AHT, a slight increase or no change in the offered load, a slight increase in utilization, and possible increase in blocking. As described above, examples of a call blast event may include school closing announcements, radio listeners calling for prizes, etc. Thus, this call blast event may cause an immediate calling surge for a few minutes during an hour. It should be noted that if this event occurred only during a few weeks of the year, but not other, then the peakedness ratio may be reported to be increased on certain months and unchanged on other months. Accordingly, the peakedness may be described as an episodic increase in peakedness.

A sixth potential cause of a trunk group blocking event may be due to “modified call blast event”, wherein the number of broadcasted calls (e.g., blaster calls) are spread across a long calling period. The exemplary characteristics exhibited by such a modified call blast event would include an increase in peg count, no change or a decrease in AHT, a slight increase or no change in the offered load, a slight increase in utilization, and possible increase in blocking. In this case the peakedness would not be changed and the blocking proportions would be much less than an unmodified call blaster event.

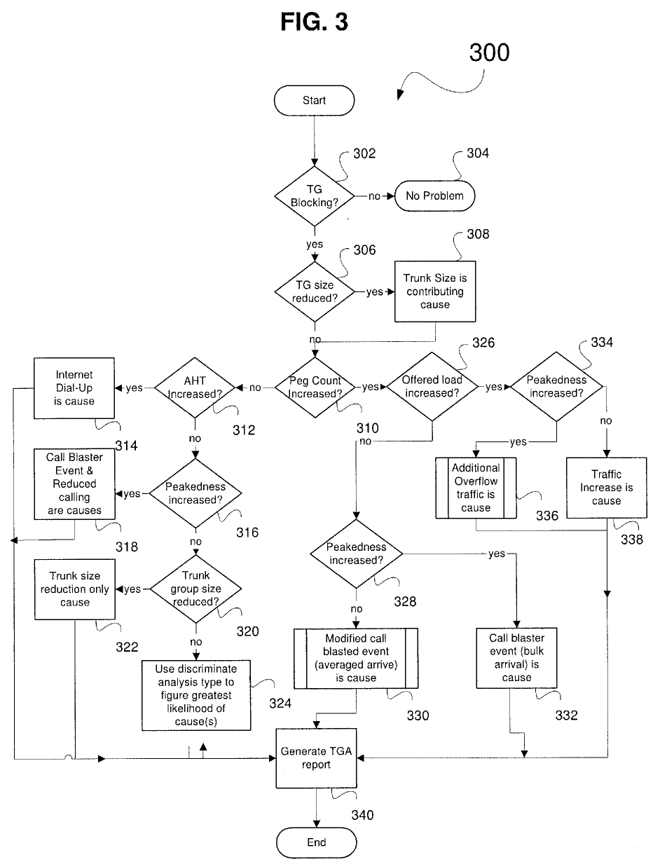

FIG. 3 shows an exemplary method 300 for categorizing a blocked trunk group event into likely causes according to an exemplary embodiment of the present invention. It should be noted that method 300 that will be discussed with reference to the components of the communication system 100 of FIG. 1A.

It is important to note that the exemplary method 300 may be one of several methods used by the TGA tool 130. In other words, the logic and reasoning performed by the TGA tool 130 is not limited to the method 300. One skilled in the art would understand that a variety of alternative logic steps (e.g., decision steps) may be performed by the TGA tool 130 in accordance with the exemplary table 200 of FIG. 2 in order to determine the cause of a trunk group blocking event. Accordingly, the method 300 serves merely as one example of the analysis.

In addition, the method 300 may be performed either continuously or on a per-need basis. In other words, the method 300 be triggered after a trunk blocking event is detected and the tool 130 may examine historical recorded data. Alternatively, the method 300 may continuously examine live data from the various TGs. Furthermore, the method 300 may either be initiated automatically (e.g., once a trunk blocking event is detected) or the method 300 may be initiated manually by personnel (e.g., administrators, trunking engineers, etc.).

As described above, the TGA tool 130 may analyze the recorded traffic from the TGs (e.g., TG 1-2, TG 2-3, and TG 2-3). Specifically, the TGA tool 130 may examine various historical characteristics and statistics from the traffic in order to determine the type of problem that may have caused a trunk group blocking event. Accordingly, the TGA tool 130 may examine the data of past events in order to identify a cause of a trunk blocking event. Once the type of problem can be determined, the information may be reported to the personnel (e.g., administrators, trunking engineers, etc.) of the service provider 110. Accordingly, this information may allow the service provider 110 to quickly assess the event and efficiently resolve the problem. Furthermore, the service provider 110 may supply this information to a regulatory agency (e.g., state governments) in order to seek exemption from any potential penalties resulting from the trunk blocking event.

Beginning with step 302, the method 300 may determine if there was trunk blocking event during a designated period of time (e.g., during a specific calling hour). If there was no blocking event, then the method may advance to step 304 wherein the TGA tool 130 may determine that there is no blocking problem. However, if there is a blocking event, then the method 300 may advance to step 306.

In step 306, the method 300 may determine if the trunk size was reduced. Specifically, the TGA tool 130 may compare system records to historical records. If the TG size was not reduced, then the method 300 may advance to step 310. However, if the TG size was reduced, then the method 300 may advance to step 308 wherein the TGA tool 130 may designate that “Reduced Trunk Size” is a contributing cause to the blocking event. Once this designation is made, the method 300 may advance to step 310.

In step 310, the method 300 may determine if there was an increase in the peg count on the system 100. The peg count may be defined as the number of arriving calls for a unit of time. Accordingly, the peg count is a rate. These calls may be presumed to arrive randomly for primary high use TGs. Therefore, the TGA tool 130 may monitor the recorded peg count in order to detect an increase in the rate. As indicated in the exemplary table 200 of FIG. 2, an increase in the peg count may indicate that the cause of the trunk group blocking event is any one of increased traffic, additional overflow traffic, or a call blast event. If there was not an increase in the peg count, the method 300 may advance to step 312. If there was an increase in the peg count, the method 300 may advance to step 326.

As discussed above, the AHT, or call duration, may be estimated to be at a predetermined length (e.g., three minutes). While this average may vary between trunk groups, it has been typically held as a reasonable estimation for voice traffic. However, this average has increased with the advent of dial-up Internet calling. Accordingly, these calls were much longer that the previous estimations (e.g., longer than three minutes). Furthermore, trunk groups may not be sized for this increased traffic and blocking proportion may increase dramatically. Thus, the increase in AHT may provide an indication to the TGA tool 130 that a blocking event is the result of added dial-up Internet traffic.

In step 312, the method 300 may determine if there was an increase in the average holding time (“AHT”) on the system 100. Specifically, the TGA tool 130 may analyze the average call duration. For example, for voice calls, the average call duration may be set to a predetermined length, such as about three minutes, and may be distributed exponentially. It should be noted that the average call duration may be longer than three minutes for Internet dial-up calling. According to the exemplary embodiments of the present invention, if there was not an increase in the AHT, the method 300 may advance to step 316. If there was an increase in the AHT, the method 300 may advance to step 314.

In step 314, the TGA tool 130 may declare the trunk blocking event to be caused by additional Internet dial-up calling traffic. Additional characteristics may allow the TGA tool 130 to detect the additional dial-up traffic, such as, an increase in utilization percentage, an increase in offered load, a possible increase in trunk blocking, a possible decrease in peakedness, and a possible decrease in peg count. The method 300 may then advance to step 340 for reporting.

In step 316, the method 300 may determine if there was a there is an increase in peakedness. Specifically, the TGA tool 130 may compare the ratio of statistical variance of occupied busy-hour trunks to the average occupied trunks. This comparison may be a measurement of a degree of randomness, or “non-randomness”, for the trunk traffic. According to the exemplary embodiments of the present invention, the measurement of peakedness may be strongly related to blocking, wherein the blocking may increase as the peakedness increases. If there was not an increase in the peakedness, the method 300 may advance to step 320. If there was an increase in the peakedness, the method 300 may advance to step 318.

In step 318, the TGA tool 130 may determine the cause of the trunk blocking event was both a call blast event and a reduced in calling. The method 300 may then advance to step 340 for reporting.

In step 320, the method 300 may once again determines if the trunk group was reduced in size. If there was a reduction in the TG size, the method 300 may advance to step 322. If there was not a reduction in the TG size, the method 300 may advance to step 324. It should be noted that to probability of there not being a reduction in the TG size (i.e., advancing to step 324) is very unlikely.

In step 322, the TGA tool 130 may declare that TG size reduction was the only cause for blocking. Specifically, the TGA tool 130 may indicate that the trunk group blocking event is caused by a decrease in the number of trunks available to carry calls on a specific TG. The method 300 may then advance to step 340 for reporting.

In step 324, the TGA 130 uses statistical methods such as discriminate analysis to categorize the blocking cause or otherwise declares the cause to “Unknown”. The method 300 may then advance to step 340 for reporting.

As described above, the method 300 may advance to step 326 upon if the peg count is determined to have increase in step 310. Accordingly, in step 326, method 300 may determine if there was a there is an increase in the offered load. Specifically, the TGA tool 130 may examine the number of trunk occupied. If there was an increase in the offered load, the method 300 may advance to step 334. If there was not an increase in the offered load, the method 300 may advance to step 328.

In step 328, the method 300 may determine if there was a there is an increase in peakedness. As described in step 316, the TGA tool 130 may compare the ratio of statistical variance of occupied busy-hour trunks to the average occupied trunks. It should be noted that the determination in step 328 may be a “fuzzy logic” question. In other words, the increase in peakedness may not just be slight, but must be important enough to trigger a substantial increase in peakedness. If there was a substantial increase in peakedness, the method 300 may advance to step 332. If there was not a substantial increase in peakedness, the method 300 may advance to step 330.

In step 330, the TGA tool 130 may declare that the likely cause of the trunk blocking event was a “modified blaster event”. As described above, the modified blaster event may be manifested by many short calls spread over the entire calling hour. Accordingly, this may result in lower call blocking, and a likely lower “AHT”. The method 300 may then advance to step 340 for reporting.

In step 332, the TGA tool 130 may declare that a call blast event has occurred. As described above, the call blast event may occur when a bulk arrival of many calls occur is short time period, thereby resulting in a blocking of a TG for a short period. The method 300 may then advance to step 340 for reporting.

As described above, the method 300 may advance to step 334 upon if the offered load is determined to have increase in step 326. Accordingly, in step 334, the method 300 may determine if there was a there is an increase in peakedness. As described in step 328, the TGA tool 130 may use fuzzy logic to compare the ratio of statistical variance of occupied busy-hour trunks to the average occupied trunks. If there was a substantial increase in peakedness, the method 300 may advance to step 336. If there was not a substantial increase in peakedness, the method 300 may advance to step 338.

In step 336, the TGA tool 130 may determine the trunk blocking event to be likely caused by additional overflow traffic. For instance, the overflow traffic may be the result of an erroneous trunk transaction sending traffic to a specific TG. The method 300 may then advance to step 340 for reporting.

In step 338, the TGA tool 130 may determine the cause of the trunk blocking event to be the result of increased traffic (e.g., increased calling). Specifically, the TGA tool 130 may detect an increased number of calls having the same (or similar) average call length and arrival rate with no immediate increase in the TG size. The method 300 may then advance to step 340 for reporting.

In step 340, the method 300 may provide a TGA report of the analysis provided by the TGA tool 130. Specifically, this report may summarize each occurrence of trunk blocking group events and provide a corresponding casual category responsible for each event. Therefore, the TGA report may enable a trunk administrating group to determine whether further action (or any action) is required, as well as which action should be followed. In other words, this report may allow trunk engineers to have an immediate basis for their actions while providing evidence to support their decisions. Furthermore, the report may allow the service provider 110 to avoid paying costly state-imposed blocking penalties. Accordingly, the service provider 110 may accumulate evidence for state regulatory agencies that may identify the cause of the trunk blocking group event as being exempt from any penalties.

It will be apparent to those skilled in the art that various modifications may be made in the present invention, without departing from the spirit or the scope of the invention. Thus, it is intended that the present invention cover modifications and variations of this invention provided they come within the scope of the appended claimed and their equivalents.

What is claimed is:

1. A method, comprising:
analyzing network traffic from at least one trunk group;
detecting a trunk group blocking event; and
categorizing a cause of the trunk group blocking event based on the analyzed network traffic.

2. The method of claim 1, wherein the analyzing step includes at least one of detecting a change in a peg count, detecting a change in an average holding time, detecting a change in an offered load, detecting a change in trunk group size, detecting a change in a utilization percentage, and detecting a change in peakedness ratio.

3. The method of claim 2, wherein the cause of the trunk group blocking event is categorized as an increase in calling traffic when:
the peakedness ratio is unchanged, and
an increase is detected in the peg count, the offered load, and the utilization percentage.

4. The method of claim 2, wherein the cause of the trunk group blocking event is categorized as a reduction in trunk group size when:
the peakedness ratio, the peg count, the offered load, and the average holding time are unchanged, and
an increase is detected in the utilization percentage.

5. The method of claim 2, wherein the cause of the trunk group blocking event is categorized as an increase in Internet dial-up traffic when:
an increase is detected in the average holding time, the offered load, and the utilization percentage, and
the peg count and the peakedness are each one of unchanged and decreased.

6. The method of claim 2, wherein the cause of the trunk group blocking event is categorized as a call blast when:
an increase is detected in the peg count, the utilization percentage and episodic increase in the peakedness,
the offered load is one of unchanged and increased, and
the average holding time is one of unchanged and decreased.

7. The method of claim 2, wherein the cause of the trunk group blocking event is categorized as an increase in overflow traffic when:
an increase is detected in the peg count, the average holding time, the offered load, the utilization percentage, and the peakedness.

8. A system, comprising:
a trunk group analyzing tool for analyzing network traffic from at least one trunk group, detecting a trunk group blocking event, and categorizing a cause of the trunk group blocking event based on the analyzed network traffic.

9. The system of claim 8, wherein the trunk group analyzing tool performs at least one of detecting a change in a peg count, detecting a change in an average holding time, detecting a change in an offered load, detecting a change in trunk group size, detecting a change in a utilization percentage, and detecting a change in peakedness ratio.

10. The system of claim 9, wherein the cause of the trunk group blocking event is categorized as an increase in calling traffic when:
the peakedness ratio is unchanged, and
an increase is detected in the peg count, the offered load, and the utilization percentage.

11. The system of claim 9, wherein the cause of the trunk group blocking event is categorized as a reduction in trunk group size when:
the peakedness ratio, the peg count, the offered load, and the average holding time are unchanged, and
an increase is detected in the utilization percentage.

12. The system of claim 9, wherein the cause of the trunk group blocking event is categorized as an increase in Internet dial-up traffic when:
an increase is detected in the average holding time, the offered load, and the utilization percentage, and
the peg count and the peakedness are each one of unchanged and decreased.

13. The system of claim 9, wherein the cause of the trunk group blocking event is categorized as a call blast when:
an increase is detected in the peg count, the utilization percentage and episodic increase in the peakedness,
the offered load is one of unchanged and increased, and
the average holding time is one of unchanged and decreased.

14. The system of claim 9, wherein the cause of the trunk group blocking event is categorized as an increase in overflow traffic when:
an increase is detected in the peg count, the average holding time, the offered load, the utilization percentage, and the peakedness.

15. A computer readable storage medium storing a set of instructions executable by a processor, the set of instructions being operable to:
analyze network traffic from at least one trunk group;
detect a trunk group blocking event; and
categorize a cause of the trunk group blocking event based on the analyzed network traffic.

16. The computer readable storage medium of claim 15, wherein the analyze step includes at least one of detecting a change in a peg count, detecting a change in an average holding time, detecting a change in an offered load, detecting a change in trunk group size, detecting a change in a utilization percentage, and detecting a change in peakedness ratio.

17. The computer readable storage medium of claim 16, wherein the cause of the trunk group blocking event is categorized as an increase in calling traffic when:
the peakedness ratio is unchanged, and
an increase is detected in the peg count, the offered load, and the utilization percentage.

18. The computer readable storage medium of claim 16, wherein the cause of the trunk group blocking event is categorized as a reduction in trunk group size when:
the peakedness ratio, the peg count, the offered load, and the average holding time are unchanged, and
an increase is detected in the utilization percentage.

19. The computer readable storage medium of claim 16, wherein the cause of the trunk group blocking event is categorized as an increase in Internet dial-up traffic when:
an increase is detected in the average holding time, the offered load, and the utilization percentage, and
the peg count and the peakedness are each one of unchanged and decreased.

20. The computer readable storage medium of claim 16, wherein the cause of the trunk group blocking event is categorized as a call blast when:
an increase is detected in the peg count, the utilization percentage and episodic increase in the peakedness,
the offered load is one of unchanged and increased, and
the average holding time is one of unchanged and decreased.

21. The computer readable storage medium of claim 16, wherein the cause of the trunk group blocking event is categorized as an increase in overflow traffic when:
an increase is detected in the peg count, the average holding time, the offered load, the utilization percentage, and the peakedness.
